(19) United States
(12) Patent Application Publication
(10) Pub. No.: US 2012/0317051 A1
(43) Pub. Date: Dec. 13, 2012

(54) System and Method for Delegated Pricing and Quote Maintenance for Trading of Dependent Financial Instruments

(76) Inventor: Charles H. Tall, IV, Queensbury, NY (US)

(21) Appl. No.: 13/155,137

(22) Filed: Jun. 7, 2011

(51) Int. Cl. G06Q 40/00

(52) U.S. Cl. 705/36 R

(57) ABSTRACT

System and method for delegated quote generation for a dependent financial instrument includes receiving a delegated pricing parameter vector for the dependent financial instrument, the delegated pricing parameter vector based at least in part on a plurality of market parameter fluctuations within which to price the dependent financial instrument, and generating a quote for the dependent financial instrument remotely from the market participant computer system in accordance with a plurality of parameters falling within the plurality of market parameter fluctuations in the delegated pricing parameter vector.

### FIELD OF THE INVENTION

This invention relates generally to the field of electronic financial trading systems and more specifically to pricing, quote maintenance, and electronic trading of dependent financial instruments, including derivatives.

### BACKGROUND OF THE INVENTION

Today's financial exchanges have evolved into electronic execution and matching platforms, using vast amounts of bandwidth and requiring market professionals to invest heavily in technology to support being exchange members in various capacities. Speed and latency are of utmost importance as well as transparency and fairness. There has been a coincident mushrooming of algorithmic activity and the term High Frequency Trading (HFT) has been coined as a result. While poorly defined by most standards, it is the activity most often associated with negative consequences and events such as the Flash Crash of May, 2010.

The options marketplace requires even more significant bandwidth than stock and futures marketplaces due to the fact that a typical underlying security (e.g., stock, commodity, ETF, among others) with listed options in the U.S. has multiple months of multiple strikes competitively listed on multiple electronic trading venues. Currently, more than 3500 securities in the U.S. have listed options resulting in more than 350,000 option listings. These options are often multiply-listed on as many as nine competing options exchanges resulting in more than 2,600,000 option prices being distributed across the financial community around the world (data as of May, 2011). When one considers that these option prices are being updated due to any changes in the underlying securities or changes in market conditions, one can begin to get a sense of the sheer volume of data being transported. Often, option message rates have exceeded 4,000,000 messages per second being delivered through the financial community. Thus, the technological issues in the options marketplace are far more demanding than those required to handle the less than 5000 individual equity securities and futures actively traded today in the U.S.

Among the option market participants there are several broad types of members and order generators. There are those who are obliged to maintain two sided quotes and provide market liquidity in their assigned options, typically called market makers (MMs), and those who trade options (e.g., traders) by submitting individual orders on selected options at times and prices of their choosing. Other market participants, the electronic exchanges, coordinate the electronic trading and clearing activities.

The exchanges provide the forum for this to take place and the nine current U.S. option exchanges, as well as many other option exchanges around the world, are in competition with one another. They create schemes and incentives to attract both market makers and traders to bring their business to their exchange. The exchanges would like option markets to be as efficient (or tight in terms of the bid/ask spread) as possible to further give the appearance of the exchange providing the best liquidity. They also have a variety of reward and sharing mechanisms to further incent market makers to make tighter markets so as to further increase the likelihood of trade happening on a particular exchange.

Typical option market making theory and practice involves one pricing and hedging options using the underlying security upon which the options are listed. Hedges are attempted to be done at the security's price upon which the options are modeled to capture the “edge” associated with the traded price of the option and the trading price of the security. The frequent price and quantity changes of an underlying security create likewise a frequent number of option price and quantity posting updates by the market makers due to the new underlying price and quantity.

An example of this cycle can be made clear by examining a highly competitive option and its associated underlying: the E-mini option listed and cleared on the CME exchange and also traded electronically and the E-mini underlying security (a miniature version of the S&P 500 index futures contract) traded on the Globex platform and cleared at the CME. The E-mini is a very active futures contract that trades currently at a level of about 1250 in tick intervals of 0.25. There exist options with expirations in the first three months totaling more than 500 calls and 500 puts. Further out, there are a total of 1000 calls and 1000 puts covering expirations up to one year. The options are traded in either 0.25, 0.10, or 0.05 price tick increments, depending upon the price of the option. In a perfect world, a market maker would place his best markets at the exchange on all 2000-odd options with a known underlying price level. When the underlying price changes, the market maker would replace those option quotes that need altering with his new best market quotes respecting the new underlying price without risk or concern of time lag, bandwidth utilization, number of messages sent, and the like. In reality, on small price or quantity changes of the E-mini future, only a medium fraction of the 2000 options quoted would need be to replaced, but if the underlying price or quantity change is more than a minimum amount, then the number of option quotes to be updated (i.e., re-quoted by the market maker) approaches a much greater percentage. Even though a single option contract has not yet traded, the mere tick change of the underlying security, such as the E-mini, creates hundreds of derivative quote message updates. The above described messaging example involves just one market maker. However, there are fifteen (15) market makers admitted to maintain quotes on this product at the above exchange and this process is common among all market makers, creating the multiple updates and simultaneous bursts of traffic at the exchange upon any change in the underlying price level or quantity bid and offered of the underlying.

The exchange has an understandable limited amount of bandwidth and computing power and therefore allocates the use of these resources to the market makers. The market makers then need to manage their use of these resources in such a way as to maximize their expected contribution to the marketplace, while not getting “stuck” with trades from stale quotes that were not updated in a timely fashion resulting in losses. The end result is that the world is not able to see and trade the market makers' best prices. The world is seeing a game theory-optimized picture of the best market that a market maker is capable of making given the timing and bandwidth constraints placed in the marketplace and the games other market participants are playing to optimize their own situations. The exchanges' and the public's best interests are not being served in this structure for the pricing of derivatives. In Europe, this limitation has strongly influenced the options marketplace and is a primary reason why more than 75% of the derivatives market is traded off exchange in a prearranged fashion and merely cleared at the exchanges. The market makers are not able to represent their best markets electronically, but must still rely on the traditional telephone brokerage market to communicate their best markets in the derivative instruments they trade. The markets displayed on the screens are substantially wider than the markets being traded “upstairs” over the telephone.

The point in time that an underlying security price is changing is also often a point at which traders are trying to “click” or execute option trades they see on the electronic screens in response to the observed security price change, which further exacerbates the traffic or bandwidth problem. There have even been traders that have gamed the market makers in such ways so as to take advantage of this time/message lag. For instance, certain traders have injected quotes and orders for independent securities that were known to cause a change in the dependent security pricing and/or quantity levels to a level the trader wished to trade, executed his trade and then canceled his order for the independent security, while never intending to execute the trade of the independent security. Since the exchange handles each message event it receives (quotes, orders, cancelations, or modifies) in a serial fashion, the additional traffic created by system gaming and/or underlying price updates puts an additional load on the processing resources.

Consequently, market participants, including trading firms, spend tremendous resources to make sure they are as fast as possible so that their messages arrive at the exchange message processing queues ahead of other participants. This has created an incredible speed race that has market making firms and exchanges spending hundreds of millions of dollars annually and this can be a race that has no end. These costs are not spent by market makers and traders to improve market efficiency, they are spent to make sure they are able to get stale quotes out of the way and/or prey on others who are not fast enough to get their quotes out of the way. Keep in mind - it is often the case that the only thing that has had any change is the underlying price or quantity of the security upon which the options are based.

The evolution of today's financial exchanges into electronic execution and matching platforms has escalated competition among various platforms with the primary differentiators being speed, consistency and reliability. The continuous improvements in computer processing and network speeds result in speed increases in the primary stock and futures marketplace. However, further requirements for the increases in bandwidth capacity, processing power and speed in the option marketplace grow at an even more demanding rate due to the fact that each stock or future typically has several hundred listed derivatives at multiple exchanges at any given time. The options exchanges have had to increase their technology costs by hundreds of millions of dollars to handle the billions of additional quote message traffic from market makers. This dramatic increase in quoting activity is the result of the far more frequent underlying financial instrument price changes that come from the fast exchanges on which the underlying trades, with no associated increase in market quality or bona fide option turnover.

If the market makers were to present the best markets they wish to make in a given option or series of options, they would need to modify most or all of their quotes on each and every update of the underlying security, including quantity updates, not just price level updates. This option quote message traffic would exceed even the most advanced exchanges' system capacities and even if the exchanges would be able to handle this traffic, the practical situation is that no market maker would place their best markets into the marketplace without the complete assurance that the underlying security price and other market conditions upon which the markets are based are reliable and tradable. In fact, most market makers update their options markets in reaction to an event that has already happened: the underlying price became “out of bounds” for the market maker to be comfortable with the quote he or she has in the market. Thus, in the current exchange architectures, the option market makers need to make markets wider to allow for the uncertainty of the underlying price being available to hedge with, if required. For example, the often quick and dramatic price changes of the E-mini futures contract require that option market makers post their markets wider than they would if they could be assured of obtaining the appropriate hedge of their potential option trade with the E-mini contract. Likewise, the physical constraints of the presently architected systems also require the market maker to make wider markets to offset the risk of message throttling due to resource constraints from the exchange associated with bursts of message traffic that may occur at any time or during busy trading periods. The end result is that the marketplace, even during quiet periods, is not presented with the best markets the market makers are willing to make and the market quality is focused on only a small subset of the thousands of options that are listed for trading.

Additionally, the emphasis the exchanges place on the market makers to improve their quality of markets has resulted in a winner-take-all race with the speed of quote management creating the winner, not the willingness to commit capital to buffer market flows of supply and demand or to absorb option risk. As the variance of networking delays, processing queue delays and other issues relating to technology (or jitter) shrinks across the systems and the speeds increase, the market maker who is able to turn around the information the fastest becomes the one and only winner. A market maker that is not able to match the speed of the fastest, all other things being equal, becomes prey to the fastest. For example, the fastest market maker becomes the one that establishes the best possible price level for an option because of his or her own ability to react to the underlying security price changes, not based necessarily upon the market maker's willingness to absorb option risk. We can evaluate this by looking at an example of the extreme case where jitter has been reduced to zero and the fastest market maker is faster than the second (and the third, fourth, and so on) by only one microsecond, for instance. On those occasions that the underlying market changes quickly, and the price level that the fastest market maker was bidding for an option becomes the price that any market maker is now willing to sell the option (due to the underlying security's rapid price change), the fastest market maker submits his modified quotes to the exchange one microsecond ahead of the second market maker, and the second market maker ends up buying from the first market maker. While this is logical in one context, it is contrary to two of the marketplace's and the exchanges' primary functions, those being to provide a forum that permits the exchange of risks between consenting members and participants and providing a forum that produces the best possible conditions for competitive pricing. This is the current vicious cycle with which the exchanges and market makers or market liquidity providers are wrestling in the options market. The market makers spend multiple millions of dollars each in technology enhancements to be first while placing more demands on the exchanges to spend tens or even in excess of one hundred million dollars each in technology to handle the messages intended to provide their options markets to the world faster and better than the other exchanges. At the same time, the exchanges want more quality, such as tighter markets, from the market makers.

In this race, the only winner is the market making firm or liquidity provider with the fastest turnaround time, and the loser is the marketplace as a whole and the exchanges due to the decreased market quality, including transactions being forced to off-floor methods (e.g., block trades, telephone market, over-the-counter transactions). While trades involving stocks, futures, and other “delta-one” products are primarily alpha-based risk transfers, options and securities with optionality are designed to transfer non-alpha based risk characteristics of a security. The current derivatives trading architecture employed by the option exchanges results in the exchanges failing in their ability to provide an adequate functional forum for efficient and fair risk transfer.

### BRIEF SUMMARY OF THE INVENTION

Embodiments of the invention provide a system and method for pricing and trading a dependent financial instrument, including derivatives, by way of delegating quote generation (e.g., price and quantity) for the dependent instrument to various market participants, including but not limited to electronic exchanges, market makers, traders, and hedge funds. Unlike existing spread or complex orders, embodiments of the invention allow quoting and trading a dependent security independent from any requirement to trade any other constituent of an order, thereby further reducing the bandwidth and processing constraints.

In one aspect of the invention, a computer implemented method for delegated quote generation for a dependent financial instrument is provided. The method comprises receiving, via a network, a delegated pricing parameter vector for the dependent financial instrument, the delegated pricing parameter vector based at least in part on a plurality of market parameter fluctuations within which to price the dependent financial instrument, the market parameter fluctuations predetermined by a market participant computer system. The method further includes generating a quote for the dependent financial instrument remotely from the market participant computer system in accordance with a plurality of parameters falling within the plurality of market parameter fluctuations in the delegated pricing parameter vector.

In another aspect of the invention, a computer implemented method for delegated quote generation for a dependent financial instrument is provided. The method comprises transmitting, via a network, a delegated pricing parameter vector for the dependent financial instrument, the delegated pricing parameter vector based at least in part on a plurality of market parameter fluctuations within which to price the dependent financial instrument, the market parameter fluctuations predetermined by a market participant computer system. The method further comprises causing the dependent financial instrument to be priced remotely from the market participant computer system in accordance with a plurality of parameters falling within the plurality of market parameter fluctuations in the delegated pricing parameter vector.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a schematic diagram illustrating a dependent financial instrument trading architecture in accordance with an embodiment of the invention;

FIG. 2 is a schematic diagram illustrating another embodiment of the dependent financial instrument trading architecture of FIG. 1;

FIGS. 3-4 are schematic diagrams illustrating additional embodiments of the dependent instrument trading architecture of FIG. 1;

FIG. 5 is a flow-chart illustrating a method for delegated pricing of a dependent financial instrument in accordance with an embodiment of the invention; and

FIG. 6 is a schematic diagram illustrating an embodiment of hardware components for implementing embodiments of the invention of FIGS. 1-5.

### DETAILED DESCRIPTION OF THE INVENTION

The following examples further illustrate the invention but, of course, should not be construed as in any way limiting its scope.

Embodiments of the invention provide a system and method for pricing and trading a dependent financial instrument, including derivatives, by way of delegating quote and order generation (e.g., price and quantity) for the dependent instrument to various market participants. As used herein, the terms “dependent financial instrument,” “derivative,” derivative instrument” or “derivative product” entail any financial instrument (e.g., an option, a future contract, a swap), security, or a collection of financial instruments or securities, that is priced based upon one or more parameters and/or attributes associated with one or more other financial instruments or securities, referred to as “underlying,” “independent,” or “lead” financial instruments or securities. Alternatively or in addition, as those skilled in the art will realize, the following disclosure is also applicable to delegated pricing and trading of any dependent financial instrument that is priced in accordance with one or more external parameter variations, including but not limited to weather variations, crop production variations, time of day, economic or non-economic news releases, trading volume variations of an underlying/independent or lead security, and the like.

In an embodiment, a market participant, such as a market maker that makes a market in a particular dependent financial instrument, generates and distributes a delegated pricing parameter vector to other market participants. The delegated pricing parameter vector includes market parameter fluctuation ranges within which the market maker is willing to price the dependent financial instrument, such as a derivative, as well as parameters for quote generation and management. Preferably, the delegated pricing parameter vector includes a validity price range for an underlying security on which the dependent or derivative product is based, where the delegated pricing parameter vector is valid for the corresponding price range of the underlying security. When the underlying security price falls within the underlying security validity price range, the market participants that receive the delegated pricing parameter vector are able to locally generate quotes of the derivative product based upon the delegated pricing parameter vector. This allows the best markets to be presented locally and removes the need for the market maker to forward quotes individually of the derivative product to the exchange for subsequent distribution to other market participants. Consequently, instant quotes of the dependent or derivative products are derived locally at each market participant's computer system, thereby greatly reducing processing and bandwidth constraints and overall technology burden, as well as reducing the current types of system “gaming” commonly associated with the timing inefficiencies and capacity constraints of the current derivative trading systems.

As further discussed in the following embodiments, the market maker that makes a market in a particular derivative instrument forwards and periodically updates the delegated pricing parameter vector for the derivative to computer systems associated with various market participants, such as exchange computer systems, other market maker computer systems, and trader computer systems, for example. In an embodiment, the delegated pricing parameter vector is generated by a hedge fund trading computer system. In embodiments, the delegated pricing parameter vector may contain dual-sided quotes (e.g., bid and ask quotes generated by a market maker computer system) and/or single-sided orders (e.g., buy or sell parameters for order placement and execution originating from any market participant).

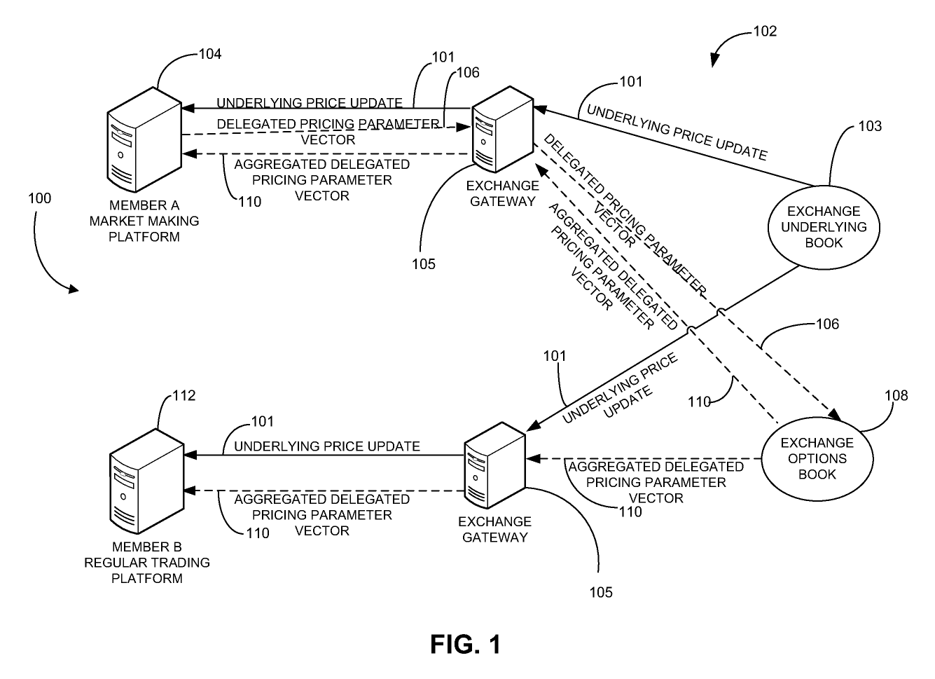

Turning to FIG. 1, a dependent instrument trading architecture 100 in accordance with an embodiment of the invention is shown. Upon receiving a price update 101 for the underlying security from a financial exchange computer system 102, a market maker computer system 104 sends out a delegated pricing parameter vector 106 to the exchange computer system 102. The exchange computer system 102 comprises an exchange underlying book server 103, an exchange options book server 108, as well as a plurality of exchange gateways 105 that relay the information between the exchange 102 and other market participants.

In an embodiment, the exchange options book computer server 108 aggregates the delegated pricing parameter vectors received from multiple market makers that make markets in their corresponding derivative products (and/or other market participants in case of buy/sell parameter vectors for order generation) for subsequent distribution among all market participants. Alternatively, as discussed in further detail below, aggregation and redistribution of delegated pricing parameter vectors among market participants may be performed by a market aggregator server associated with the exchange, a third-party provider, or a market participant.

Preferably, the delegated pricing parameter vector 106 includes a plurality of flexible parameters, including non-linear parameters, that allow the recipient to locally generate a quote (e.g., price and quantity) for the dependent or derivative instrument, such as an option, instead of waiting for the market maker that makes the market in the option to generate and forward the option quote to the exchange and for the exchange to subsequently forward the market maker-generated option quote to the recipient. The local generation of derivative price quotes further allows locally generating an order book representation based on the pricing parameters in the delegated pricing parameter vector 106, thereby presenting a “meta” order book at the market participant's computer system. An embodiment of a delegated pricing parameter vector 106 with hypothetical values for the corresponding parameters is shown in Table 1 below with reference to locally generating a quote for an option instrument.

TABLE 1
Delegated Pricing Parameter Vector Example

| Parameter Name | Value Example |
|---|---|
| Independent Security | E-Mini March 2011 |
| Dependent Security | E-Mini March 2011, 1225 |
| | call |
| Underlying Reference | 1202.00, 1204.00, 1206.00 |
| Prices | |
| Dependent Best Prices at | 3.83975, 3.87822, 4.13873, |
| Reference Prices (bid/ask | 4.17832, 4.45455, 4.49225 |
| pairs) | |
| Option Deltas | 0.14500, 0.15437, 0.16500 |
| Option Gammas | 0.00900, 0.01000, 0.01100 |
| Maximum Quantity at Best | 75, 50 |
| Price (buy/sell) | |
| Additional Quantity per | 25, 15 |
| 0.01 change in price of | |
| derivative instrument | |
| (buy/sell) | |
| Maximum Total Quantity | 300, 200 |
| (buy/sell) | |
| Validity Range of the | 1202.00-1206.00 |
| Underlying Price | |
| Rounding Rules | 0.80, 0.40 |
| Hedging Instructions | 20, 80% |
| Disclosure Rules | Full, None |

Thus, an embodiment of the delegated pricing parameter vector for a derived instrument (e.g., March 1225 call option on the March E-Mini contract in Table 1 above) based upon the independent instrument (e.g. E-mini futures contract expiring in March 2011) includes such parameters as: underlying reference prices (e.g., 1202.00 1204.00, 1206.00) with corresponding best bid and ask prices the market maker is willing to make in the derived instrument at the reference prices (e.g., [3.83975, 3.87822], [4.13873, 4.17832], [4.45455, 4.49225]), price and quantity change management references associated with each underlying reference price (e.g., Delta and Gamma, parameters relating to how to manage the quoted price and/or quantity of the security due to changes in price or quantity of the underlying security), derivative order quantity management instructions (e.g., maximum quantity willing to bid/offer at best bid/offer, additional quantity willing to bid or offer per extra “edge” over best market, and maximum total quantity), validity price range of the underlying reference (e.g., 1202.00−1206.00 above, which is a range of the underlying price within which the other parameters in the vector are valid and are used to locally recalculate the price and/or quantity for the derivative), and price rounding rules to be used in final determination of the posted price, (e.g., 0.80, 0.40 in Table 1 above). Option Delta is the first derivative of price change of the option (slope) due to a price change of the underlying instrument and Option Gamma is the second derivative of price change of the option (change of slope) due to a price change of the underlying instrument.

Further instructions included in the delegated pricing and trading parameter vector include Hedging Instructions (e.g., 20, 80% in Table 1 above) and Disclosure Rules (e.g., Full, None in Table 1 above). The Hedging Instructions indicate whether an option trade must be hedged and at what level the market maker is willing to take the option trade without a hedge. For instance, the minimum amount of contracts in the order which is required for a predetermined percentage of the order to be hedged is indicated (e.g., in Table 1 above, when the order includes at least 20 contracts and up to the maximum amount of contracts, 80% of contracts in the order are hedged, while option trades below 20 contracts are not hedged). Finally, the Disclosure Rules parameter indicates whether the market maker desires to disclose the full liquidity it is willing to provide, or any other aspect of the pricing parameter vector the market maker has constructed. For instance, in the above table, the market maker is willing to disclose fully the liquidity he would provide (“Full”), but not willing to disclose any of the other aspects of the vector (“None”). Those skilled in the art will realize that the parameter values in Table 1 are merely illustrative examples and that corresponding parameter values for a particular dependent financial instrument may be customized, such as by employing one or more financial trading analysis techniques to price and trade securities having high correlations of price movement to one another (e.g., Wheat and Corn, or Soy Beans, Soy Bean Meal, Soy Bean Oil, and Wheat as exemplary sets of correlated price behaviors). Alternatively or in addition, dependent and underlying or lead securities may have any relationship for which a trader or an exchange wish to delegate quoting and/or pricing determination via the foregoing delegated parameter vector(s), thereby achieving increased efficiency and transparency with respect to the historically architected pricing methods.

With the above delegated pricing parameter vector 106 for an option, the market maker's market may be remotely maintained and managed to reflect both level and quantity changes in the underlying. The additional quantity the market maker is willing to bid and offer for the dependent instrument at prices reflecting further “edge” from the best bid and offer the market maker is willing to make of the dependent instrument while all other parameters remain constant is computed and presented to the community using the Additional Quantity per 0.01 change in price of the derivative instrument parameters. In the illustrated embodiment, the exchange options book server 108 receives delegated pricing parameter vectors from multiple market participants and combines this information into an aggregated delegated pricing parameter vector 110. The exchange option book server 108 then distributes the aggregated delegated pricing parameter vector 110 containing delegated pricing parameter vectors for various derivative instruments from multiple market makers among all market participants, including market maker computer systems 104 and trading computer systems 112 for locally generating the “meta” market.

As an example, with reference to the hypothetical parameter values of Table 1, if the underlying security market was bid 1204.00−1204.25 offered, 30 contracts bid by 20 contracts offered, the dependent option market price would be locally calculated at 4.10−4.25, with corresponding quantities being 171 contracts bid by 98 contracts offered. The ultimate bid and offer prices of the option (4.10 and 4.25) are determined by extrapolation and interpolation based upon the Underlying Reference Prices, the Dependent Best Prices at References Prices, the Deltas and the Gammas and further rounded to the required tick level using the provided rounding rules. The ultimate bid and offer quantities are determined in accordance with underlying bid and offer quantities, 30 and 20 respectively, and the supplied Maximum Quantity at Best Price, Additional quantity per 0.01 change in price of derivative instrument, and Maximum Total Quantity parameters in conjunction with price calculation.

Traditional rounding rules would suggest the bid could be 4.15, but a rounding rule of 0.80 in accordance with an embodiment of the invention set forth in Table 1 is applied. The rounding rule of Table 1 requires that the option's best price be above 4.14000, or 0.80 of a tick, before a bid of 4.15 is posted. Thus, a bid of 4.10 is posted, which is 0.03873 “relaxed”, or better theoretically than our tightest market. This relaxed amount is cached in computer readable memory for subsequent quantity calculation.

Turning to an embodiment of the calculation of the ask price of the option, suppose that the underlying security's ask price is 1204.25 and since this is not an exact reference price, we need to interpolate between reference prices of 1204.00 and 1206.00. From the reference price of 1204.00 and the reference ask value of 4.17832, we extrapolate the value we expect at 1204.25 using the delta and the gamma supplied in the pricing vector. From the reference price of 1206 and reference ask value of 4.49225, we extrapolate the value we expect at 1204.25 in the same fashion. We then weight the extrapolated values in proportion to their relative distances from the reference underlying prices to arrive at a final price. The extrapolated price at 1204.25 from reference values at 1204.00 is computed as follows: (4.17832+(1204.25−1204.00)* 0.15437+((1204.25−1204.00)̂2*0.01/2))=4.217225. The extrapolated price at 1204.25 from reference values at 1206.00 is as follows: (4.49225+(1204.25−1206.00)*0.165+((1204.25−1206.00)̂2*0.011/2))=4.220344. We now interpolate between these extrapolated prices to arrive at our best option offer at underlying price of 1204.25, as discussed in detail below. Specifically, we weight the prices extrapolated from 1204 and 1206 in proportion to their proximity to the current underlying price. The reference 1204.00 extrapolated price of 4.217225 is weighted with (1−(1204.25−1204.00)/(1206.00−1204.00))=0.875. The reference 1206.00 extrapolated price 4.220344 is weighted similarly with (1−(1206.00−1204.25)/(1206.00−1204.00))=0.125, or simply the complement to the first weight. The resulting interpolated best price is (0.875*4.217225)+(0.125*4.220344)=4.217615. As was the case in the bid, the rounding rules are applied to arrive at the best offer of 4.25, which is (4.25−4.217615)=0.032385 relaxed. This relaxed amount is also cached and used in the quantity determination of the offer.

Traditional option theory would suggest that the bid and ask quantities of the option may relate to the bid and ask quantities of the underlying as reflected by the delta of the option. In this case, the bid and ask quantities of the underlying of 30 and 20 could result in option bid and offer quantities of (30/0.15437)=194.3383 and (20/0.15437)=129.5589 by using the option delta closest to the underlying price. In practice, the quantity of options a market maker or trader is willing to buy or sell at a particular price considers more factors than simply the quantity available on the bid or offer of another security. The options carry different risks and therefore the quantities willing to be traded at a particular price also consider the risk levels the market maker or trader or hedge fund manager wants to acquire at a given price level, as well as the bid and offered quantity of the underlying instrument.

In this embodiment, the Delegated Pricing Parameter Vector includes quantity management parameters consisting of the Maximum Quantity at Best Price (25 on the bid and 15 on the offer), Additional Quantity per 0.01 change in price of the derivative instrument (25 contracts per extra 0.01 “edge” on the bid and 15 contracts per extra “edge” on the ask), and Maximum Total Quantity (300 on the bid and 200 on the offer) that is willing to be bid or offered at any level. To determine the bid and offer quantities that this vector would generate given the market situation, we first calculate the extra quantity for extra “edge” in bid and offer prices determined in the above paragraph and add this to our Maximum Quantity at Best price. This quantity is then compared to our Maximum Total Quantity number and the minimum is preserved. Finally, we compare this number to the underlying bid and offer quantities divided by the option delta as outlined above and take the minimum as the final outcome for bid and offer quantity. The bid quantity is expressed as follows: {minimum of (underlying bid quantity/option delta), (Maximum Quantity at Best Price for the bid+(extra bid edge/0.01)*Additional Quantity per 0.01 change in price of derivative instrument), Maximum Total Quantity} or in this case {minimum (30/0.15437), (75+(0.03873/0.01)*25), 300}=171, truncated to the integer from 171.825 Similarly, the offer quantity is computed as the {minimum (20/0.15437), (50+(0.032385/0.01)*15), 200}=98, truncated from 98.5775. Thus, as soon as the underlying security changes in either price level or quantity, the option market reflects the change locally by computing the option price based on the delegated pricing parameter vector 106.

For placing meta book orders, the exchange 102 receives a single-sided delegated pricing parameter vector comprising the underlying security, underlying security reference prices, dependent security bid or offer prices at the underlying security reference prices, dependent security price change management instructions, and other parameters discussed above, and can completely calculate and maintain the relevant dependent security's bid level and/or ask level, as well as other parameters. This foregoes the need for the submitter of the meta book order (e.g., a market maker or trader) to constantly “cancel and replace” orders as the submitter sees the change in the underlying price.

In one embodiment, the exchange distributes the constantly updating quotes and/or order status for the dependent securities, while in another embodiment the exchange remotely delivers the aggregated delegated pricing parameter vector having multiple price relationships for multiple options to clients' price servers in order to free the exchange from transmitting the individual option quote and order status updates. This also allows the client price servers to compute the quote and order status information. Further information and transparency of the market depth and security relationships becomes available when the exchanges broadcast complete information contained in each individual delegated pricing parameter vector to local servers, such as when the contributors to the aggregated delegated pricing parameter vector allow their entire set of vector parameters to be fully disclosed by setting the Disclosure Rules indicator of Table 1 to “Full, All.”

The handling of orders in a dependent security arriving at the exchange takes place in accordance with the combined independent order book for the instrument and the meta order book for the instrument, including specific instructions with respect to hedging included in the incoming regular order as well as the meta order. When incoming orders, including regular and meta orders per delegated pricing parameter vectors, arrive at the exchange, the exchange “locks the book” for the dependent security. Next, the exchange determines if the incoming order activates an executable trade, or match. Based on this determination, the exchange further evaluates any conditions of the match trade needing to be fulfilled, including the appropriate price levels and quantities being available in the independent securities related to the dependent security's price. The exchange also determines whether hedging is required, locks the books of the necessary independent securities, and further completes the matching of the trades to the fullest extent possible. The successfully matched trades can include dependent securities only or both dependent securities and independent securities in a bundle, depending upon the order. As is currently the case, individual regular orders for the securities are still submitted to the order book and included in this process as well.

The foregoing functionality allows for the delivery of the best markets a market maker or liquidity provider would provide when the underlying (independent) security is at the price upon actual execution. Hence, a “meta” market is created.

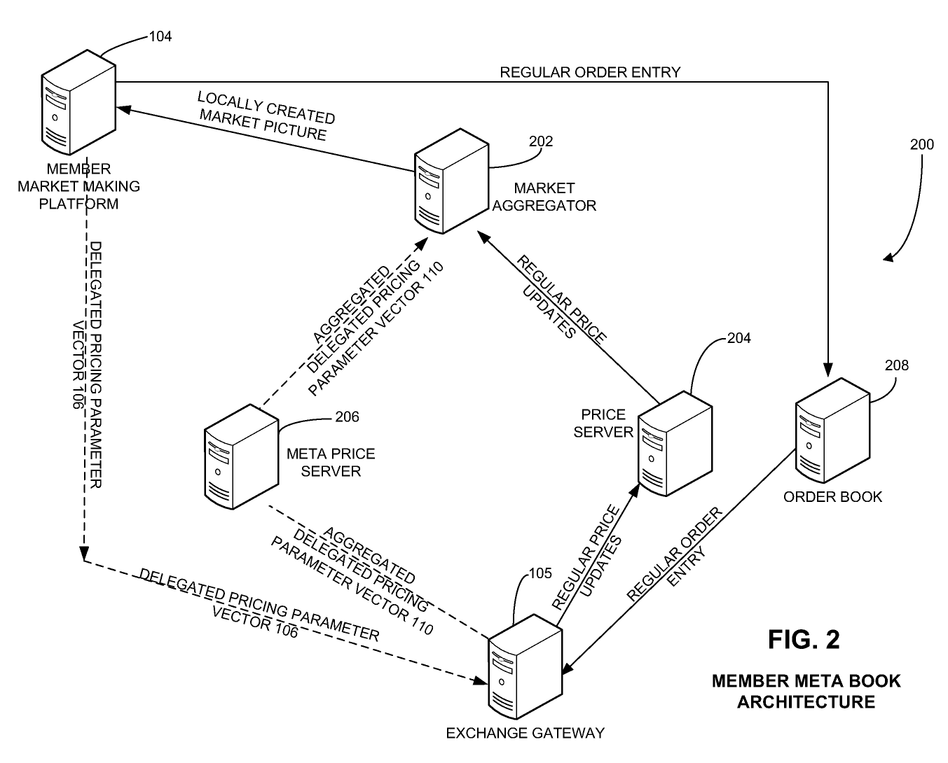

Turning to FIG. 2, a dependent instrument trading architecture 200 in accordance with another embodiment of the invention is shown. In this embodiment, a market aggregator computer system 202 receives an aggregated delegated pricing parameter vector 110 from a meta price server 206 (e.g., via the exchange gateway 105) and forwards the aggregated vector 110 to one or more market participants, such as a market maker computer system 104. Alternatively or in addition, the market aggregator system 202 also forwards the aggregated pricing parameter vector 110 to a trading computer system 112 (FIG. 1) and/or other market participants, such as other market makers, hedge funds, and exchange computer platforms. In various embodiments, the market aggregator 202 is part of a market participant's trading architecture (e.g., associated with the exchange, market maker, hedge fund, and/or trader computer platform). Alternatively, the market aggregator 202 is a third party independent service provider that is engaged in aggregating individual delegated pricing parameter vectors for particular dependent securities from multiple market participants and distributing the aggregated vector throughout the market.

As shown in FIG. 2, the market aggregator 202 preferably also receives regular price updates (e.g., non-delegated quotes) for the derivative instrument from the exchange gateway 105 via the price server 204. For entry of non-delegated regular orders, the exchange gateway 105 forwards the regular order information to the market maker computer system 104 (and/or computer systems of other market participants) via the order book 208.

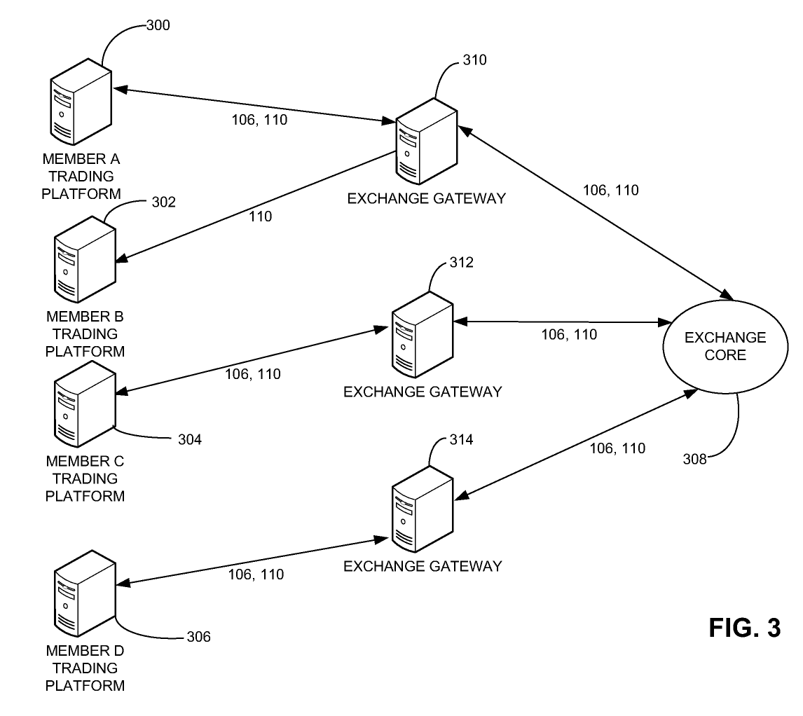

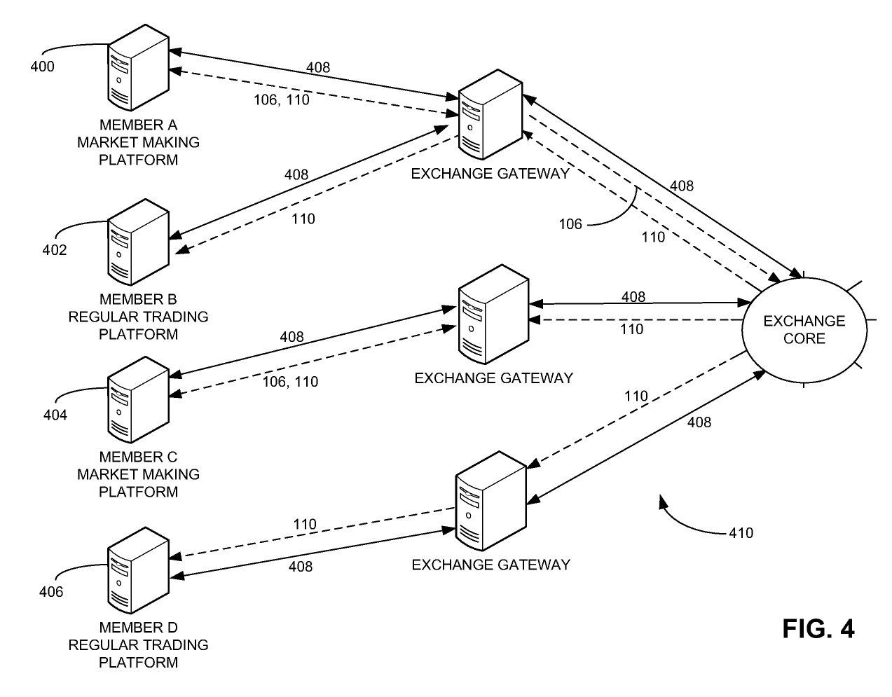

FIGS. 3 and 4 illustrate additional embodiments of the dependent instrument trading architecture. For instance, FIG. 3 illustrates an embodiment of a distribution of individual delegated pricing parameter vectors 106 among originating trading electronic computer systems/platforms 300, 304, 306 and another trading platform 302 by way of an aggregated pricing parameter vector 110. Specifically, in the embodiment of FIG. 3, the exchange core 308 receives the delegated pricing parameter vectors 106 from the member trading platforms 300, 304, 306, aggregates multiple delegated pricing parameter vectors (e.g., including those received from all other market participants) into the aggregated pricing parameter vector 110, and distributes the aggregated pricing parameter vector 110 among multiple member trading platforms 300-306 via one or more exchange gateways 310-314. In the embodiment of FIG. 4, in addition to the delegated pricing parameter vectors 106, 110 associated with the “meta market,” the market making and trading computer systems 400-406 also take part in the regular/non-delegated trading activities by communicating regular orders 408 via the exchange 410.

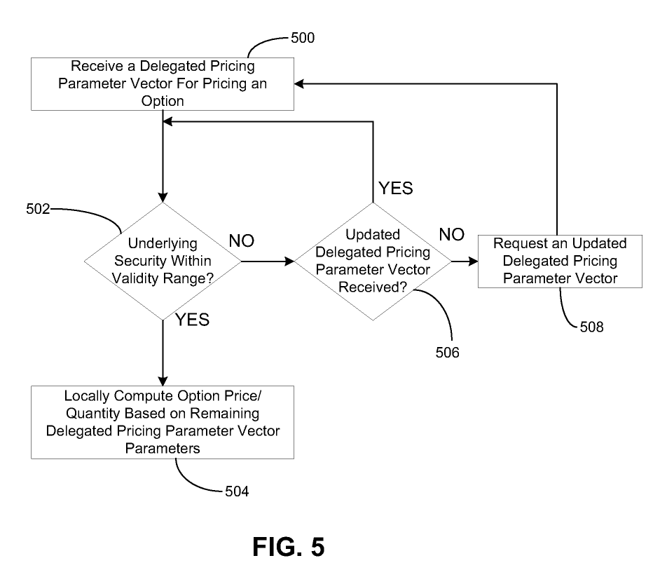

Turning to FIG. 5, an embodiment of a method for delegated pricing of a dependent instrument is shown. In step 500, a market participant's computer trading system receives a delegated pricing parameter vector (e.g., via parsing an aggregated delegated parameter vector distributed among market participants) for local pricing and quote maintenance in connection with trading a dependent financial instrument, such as an option. In step 502, based on the delegated pricing parameter vector, the market participant's computer trading system determines whether the underlying security is within the predetermined validity range (see e.g., Table 1). If so, the market participant's computer trading system locally computes the option price and quantity based on the remaining parameters discussed above in connection with Table 1, step 504. Otherwise, in step 506, a check is performed whether an updated delegated pricing parameter vector has been received in order to evaluate whether the underlying security price is within the updated validity range. In one embodiment, the market participant's computer trading system is configured to periodically check for an updated delegated pricing parameter vector. In another embodiment, shown in step 508, an updated delegated pricing parameter vector is requested.

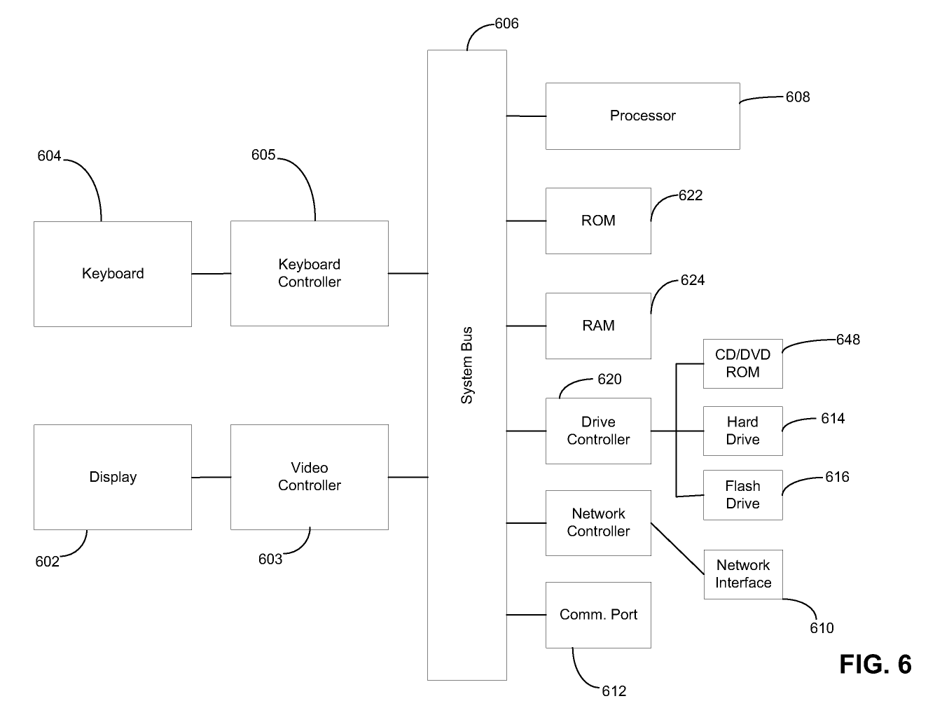

Turning to FIG. 6, an embodiment of hardware components for implementing embodiments of the invention described herein is shown with reference to a computing device 600. The computing device 600, such as a computer, a mobile computing device, including a dedicated special-purpose electronic trading computing device, includes a plurality of hardware elements, including a display 602 and a video controller 603 for presenting to the user an interface having a local representation of a meta order book of the meta market implemented in accordance with embodiments described herein, as well as a keyboard 604 and keyboard controller 605 for relaying the user input via the user interface. Alternatively or in addition, the computing device 600 includes a tactile input interface, such as a touch screen. The display 602 and keyboard 604 (and/or touch screen) peripherals connect to the system bus 606. A processor 608, such as a central processing unit (CPU) of the computing device or a dedicated special-purpose derivative trading processor, executes the computer executable instructions comprising embodiments of the delegated pricing and quote maintenance for a dependent financial instrument, as described above. In embodiments, the computer executable instructions are received over a network interface 610 (or communications port 612) or are locally stored and accessed from a non-transitory computer readable medium, such as a hard drive 614, flash (solid state) memory drive 616, or CD/DVD ROM drive 618. The computer readable media 614-618 are accessible via the drive controller 620. Read Only Memory (ROM) 622 includes computer executable instructions for initializing the processor 608, while the Random Access Memory (RAM) 624 is the main memory for loading and processing instructions executed by the processor 608.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer implemented method for delegated quote generation for a dependent financial instrument, the method comprising:
receiving, via a network, a delegated pricing parameter vector for the dependent financial instrument, the delegated pricing parameter vector based at least in part on a plurality of market parameter fluctuations within which to price the dependent financial instrument, the market parameter fluctuations predetermined by a market participant computer system; and
generating a quote for the dependent financial instrument remotely from the market participant computer system in accordance with a plurality of parameters falling within the plurality of market parameter fluctuations in the delegated pricing parameter vector.

2. The method of claim 1 wherein the market participant computer system is selected from the group consisting of a market maker computer system, a trader computer system, an electronic exchange computer system, and a hedge fund computer system.

3. The method of claim 1 wherein a market aggregator computer system aggregates and distributes a plurality of delegated pricing parameter vectors among market participants.

4. The method of claim 1 wherein the dependent financial instrument is an option.

5. The method of claim 1 wherein the dependent financial instrument is selected from the group consisting of: an option, a future contract, and a swap.

6. The method of claim 1 wherein an electronic exchange computer system receives the delegated pricing parameter vector and forwards the delegated pricing parameter vector to an external computer system for generating the quote for the dependent financial instrument at the external computer system.

7. The method of claim 6 wherein the external computer system is selected from the group consisting of: a trader computer system, a market maker computer system, and a market aggregator computer system.

8. The method of claim 6 wherein the electronic exchange computer system anonymously forwards the meta parameter vector.

9. The method of claim 1 wherein the market parameters within the delegated pricing parameter vector include a price range for an underlying security within which the delegated pricing parameter vector is valid for pricing the dependent financial instrument.

10. The method of claim 1 wherein the market parameters within the delegated pricing parameter vector include price change management instructions associated with a change in price of an underlying security.

11. The method of claim 1 wherein the market parameters within the delegated pricing parameter vector include instructions for managing the dependent financial instrument order quantity based at least in part on a change in price of an underlying security.

12. A non-transitory computer readable medium having stored thereon computer executable instructions for delegated quote generation for a dependent financial instrument, the instructions comprising:
receiving, via a network, a delegated pricing parameter vector for the dependent financial instrument, the delegated pricing parameter vector based at least in part on a plurality of market parameter fluctuations within which to price the dependent financial instrument, the market parameter fluctuations predetermined by a market participant computer system; and
generating a quote for the dependent financial instrument remotely from the market participant computer system in accordance with a plurality of parameters falling within the plurality of market parameter fluctuations in the delegated pricing parameter vector.

13. A computer implemented method for delegated quote generation for a dependent financial instrument, the method comprising:
transmitting, via a network, a delegated pricing parameter vector for the dependent financial instrument, the delegated pricing parameter vector based at least in part on a plurality of market parameter fluctuations within which to price the dependent financial instrument, the market parameter fluctuations predetermined by a market participant computer system; and
causing a quote for the dependent financial instrument to be generated remotely from the market participant computer system in accordance with a plurality of parameters falling within the plurality of market parameter fluctuations in the delegated pricing parameter vector.

14. The method of claim 13 wherein the market participant computer system is selected from the group consisting of a market maker computer system, a trader computer system, an electronic exchange computer system, and a hedge fund computer system.

15. The method of claim 13 wherein a market aggregator computer system aggregates and distributes a plurality of delegated pricing parameter vectors among market participants.

16. The method of claim 13 wherein the dependent financial instrument is selected from the group consisting of: an option, a future contract, and a swap.

17. The method of claim 13 wherein an electronic exchange computer system receives the delegated pricing parameter vector and forwards the delegated pricing parameter vector to an external computer system for generating the quote for the dependent financial instrument at the external computer system.

18. The method of claim 17 wherein the external computer system is selected from the group consisting of: a trader computer system, a market maker computer system, and a market aggregator computer system.

19. The method of claim 17 wherein the electronic exchange computer system anonymously forwards the delegated pricing parameter vector.

20. The method of claim 13 wherein the market parameters within the delegated pricing parameter vector include a price range for an underlying security within which the delegated pricing parameter vector is valid for pricing the dependent financial instrument.

21. The method of claim 13 wherein the market parameters within the delegated pricing parameter vector include price change management instructions associated with at least one of a change in price and a change in quantity of an underlying security.

22. The method of claim 13 wherein the market parameters within the delegated pricing parameter vector include instructions for managing the dependent financial instrument order quantity based at least in part on at least one of a change in price and a change in quantity of an underlying security.

23. A non-transitory computer readable medium having stored thereon computer executable instructions for delegated quote generation for a dependent financial instrument, the instructions comprising:
transmitting, via a network, a delegated pricing parameter vector for the dependent financial instrument, the delegated pricing parameter vector based at least in part on a plurality of market parameter fluctuations within which to price the dependent financial instrument, the market parameter fluctuations predetermined by a market participant computer system; and
causing a quote for the dependent financial instrument to be generated remotely from the market participant computer system in accordance with a plurality of parameters falling within the plurality of market parameter fluctuations in the delegated pricing parameter vector.

24. An electronic trading computer system for delegated quote generation for a dependent financial instrument, the system comprising:
a market participant computer system configured to transmit a delegated pricing parameter vector for the dependent financial instrument, the delegated pricing parameter vector based at least in part on a plurality of market parameter fluctuations within which to price the dependent financial instrument, the market parameter fluctuations predetermined by the market participant computer system; and
a computer system external to the market participant computer system configured to receive the delegated pricing parameter vector and generate a quote for the dependent financial instrument remotely from the market participant computer system in accordance with a plurality of parameters falling within the plurality of market parameter fluctuations in the delegated pricing parameter vector.

25. The system of claim 24 wherein the market participant computer system is selected from the group consisting of a market maker computer system, a trader computer system, an electronic exchange computer system, and a hedge fund computer system.

26. The system of claim 24 further comprising a market aggregator computer system that aggregates and distributes a plurality of delegated pricing parameter vectors among market participants.

27. The system of claim 24 wherein the dependent financial instrument is selected from the group consisting of: an option, a future contract, and a swap.

28. The system of claim 24 wherein an electronic exchange computer system receives the delegated pricing parameter vector and forwards the delegated pricing parameter vector to the external computer system for generating the quote for the dependent financial instrument at the external computer system.

29. The system of claim 24 wherein the market parameters within the delegated pricing parameter vector include a price range for an underlying security within which the delegated pricing parameter vector is valid for pricing the dependent financial instrument.

30. The system of claim 24 wherein the market parameters within the delegated pricing parameter vector include instructions for managing the dependent financial instrument order quantity based at least in part on a change in price of an underlying security.
